(19) United States
(12) Patent Application Publication
(10) Pub. No.: US 2015/0322322 A1
(43) Pub. Date: Nov. 12, 2015

(54) HEAT TRANSFER-FLUID WITH ELECTRICAL INSULATING PROPERTIES

(71) Applicant: EVONIK OIL ADDITIVES GMBH, Darmstadt (DE)

(72) Inventors: Ronny SONDJAJA,, Darmstadt (DE); Reza GHAHARY, Darmstadt (DE); Torsten Stoehr, Frankfurt (DE); Juergen GEBHARDT, Schaafheim (DE); Ines MUELLER, Gross-Umstadt (DE); Aidan S ROSE, Perkasie, PA (US)

(73) Assignee: EVONIK OIL ADDITIVES GMBH, Darmstadt (DE)

(21) Appl. No.: 14/655,607

(22) PCT Filed: Dec. 4, 2013
(86) PCT No.: PCT/EP2013/075500

§ 371 Date: Jun. 25, 2015

Related U.S. Application Data
(60) Provisional application No. 61/749,088, filed on Jan. 4, 2013.

(30) Foreign Application Priority Data
Jan. 29, 2013 (EP) 13152974.5

(51) Int. Cl. C09K 5/10

(52) U.S. Cl. CPC C09K 5/10

(57) ABSTRACT

The present invention relates to the use of a liquid composition as heat transfer fluid, characterized in that the liquid composition comprises polymers derived from at least an ethylenically unsaturated monomer or a mixture of ethylenically unsaturated monomers. Preferably, the liquid composition is used as a heat transfer fluid for electrical equipment.

The present invention relates to the use of a liquid composition comprising polymers of ethylenically unsaturated monomers as heat transfer fluids in battery systems or other applications where non-electrical conductive fluids are necessary due to safety reasons.

In recent years, energy shortage and environmental concerns have had a tremendous impact on technological advancement. The increase of environmental awareness has led to a growing interest in so called green technology, especially in the automobile industry. The demand for emission-free vehicles fueled by renewable energy sources, such as pure electric vehicles (EVs), hybrid electric vehicles (HEVs) and fuel cell electric vehicles, has gradually become more significant and is anticipated to increase in the next 20 years. The energy for such vehicles is provided and stored in batteries having a high specific energy density. Various batteries are available for EVs and HEVs, such as lead-acid, zinc/halogen, metal/air, sodium-beta, nickel metal hydride (Ni-MH) and lithium-ion (Li-ion).

To increase the performance of electric vehicles, large-scale batteries with a high current discharge are required. Due to the size and power output, these large-scale batteries generate a large amount of heat during rapid charge and discharge cycles at high current levels. Thus, batteries have to be thermally managed by cooling or dissipating heat to avoid battery malfunction and increase the life time of the battery.

Furthermore, the performance of the battery is temperature dependent. Depending on the type, batteries perform optimally only with a particular temperature range. Therefore, a proper thermal management allows optimizing battery performance.

Currently, both air- and fluid-based cooling systems are used (Rao and Wang, Renewable Sustainable Energy Reviews 15 (2011), 4554-4571). However, it has been found that air-based fan-cooling thermal management systems are less effective, despite their constructive simplicity. Liquid-based thermal management systems are currently more popular as they provide a high heat transfer capacity.

Various types of liquids have been investigated for liquid-based thermal management systems. U.S. Pat. No. 4,007,315 (Varta Batterie AG, 1977) discloses a multi-cell battery cooling system utilizing cooling elements immersed in the electrolyte. U.S. Pat. No. 3,834,945 (Eltra Corp., 1973) illustrates a water-cooled industrial battery.

Water has long been known and was popular as cooling fluid as it is easily available and has a high heat capacity. In order to extend the range of operating temperatures, mixtures of water and ethylene or propylene glycol have also been reported (Salem and Urciuoli, “Power Module Cooling for Future Electric Vehicle Applications”, Proceedings of the 25^{th} US Army Science Conference 2006).

However, as battery safety is a key issue for EVs applications and aqueous-based solutions are electrically conductive, it is of utmost importance to use a non-electrical conductive (electrically insulating) heat transfer liquid.

The use of non-electrical conductive liquids for the thermal management of batteries has been reported. WO 2010/076451 A1 (Renault, 2008) describes a device for cooling the batteries in EVs or HEVs by using a refrigerant fluid, which is also being used in an air conditioner system. WO 2011/113851 A1 (Shell International Research, 2010) illustrates the use of a lubricant as cooling and/or electrically insulating fluid for an electric battery in a Kinetic Energy Recovery System of a hybrid vehicle. In particular, WO 2011/113851 A1 discloses the use of a synthetic lubricant based on polyalphaolefin (PAO), which has a high specific heat capacity in comparison to commercially available thermal oils, as a cooling fluid.

Electrically insulating liquids may also be used as fluids for thermal management in other electrical appliances, including but not limited to transformer oil, thermal oil in electrical heavy machines, cooling liquids for static batteries, computer servers, wires and cables. For instance, several prior art documents describe use of such liquids in a cooling apparatus for computers (see e.g. U.S. Pat. No. 4,644,443, U.S. Pat. No. 6,708,515, U.S. Pat. No. 7,284,389).

The present invention therefore aims at providing an electrically insulating liquid for use as a cooling fluid, especially for electrical equipment. The electrically insulating liquid should have a high specific heat capacity and should in particular be suitable for use in thermal management systems for high power batteries. Further, the electrically insulating liquid should not be toxic or harmful to the environment.

In the present invention it has surprisingly been found that a liquid composition comprising polymers of ethylenically unsaturated monomers can be used as a non-electrical conductive thermal management fluid for batteries and other electrical equipment.

The present invention consequently relates to the use of a liquid composition as heat transfer fluid, characterized in that the liquid composition comprises polymers derived from at least an ethylenically unsaturated monomer or of a mixture of ethylenically unsaturated monomers. Preferably, the liquid composition is used as a heat transfer fluid for electrical equipment.

The inventive liquid composition may preferably be used as heat transfer fluid for electrical equipment like electric batteries, electric motors, electric transformers, electric power converters, electric capacitors, fluid-filled transmission lines, fluid-filled power cables, and computers.

The liquid composition of the present invention has a high specific heat capacity, namely a specific heat capacity of at least 1.80 kJ/kg/K, more preferably at least 1.9 kJ/kg/K, measured at 40° C. according to ASTM E 1269. Even more preferably, the liquid composition has a specific heat capacity of at least 1.80 kJ/kg/K, more preferably at least 1.9 kJ/kg/K, measured at temperatures between 20° C. to 100° C., in particular at 40° C., 60° C., and 100° C., according to ASTM E 1269.

The polymers used in the present invention have a low viscosity, preferably a kinematic viscosity of less than 100 mm²/s, more preferably less than 25 mm²/s, most preferably less than 15 mm²/s, measured at 100° C. according to ASTM D 445.

In a preferred embodiment the ethylenically unsaturated monomers are compounds according to formula (I)

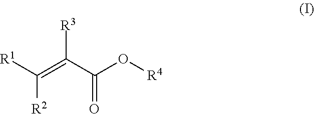

wherein R¹ and R² independently represent a hydrogen atom or a group of the formula —COOR⁵, R³ represents a hydrogen atom or a methyl group, R⁴ represents a C₁ to C₃₀ alkyl group, a C₂ to C₃₀ alkenyl group, a C₂ to C₃₀ alkinyl group or a C₃ to C₃₀ cycloalkyl group, and R⁵ represents a hydrogen atom or a C₁ to C₃₀ alkyl group, a C₂ to C₃₀ alkenyl group, or a C₂ to C₃₀ alkinyl group.

In a particularly preferred embodiment, R¹ and R² represent hydrogen atoms, R³ represents a hydrogen atom or a methyl group, and R⁴ represents a C₁ to C₃₀ alkyl group, preferably a C₆ to C₁₈ alkyl group, even more preferably a C₁₀ to C₁₅ alkyl group.

In the context of the present invention, these preferred compounds are also called “Cₑ (meth)acrylic acid ester” or “Cₑ (meth)acrylate”, referring to compounds according to formula (I), wherein R¹ and R² represent hydrogen atoms, R³ represents a hydrogen atom or a methyl group, and R⁴ represents a Cₙ alkyl group.

In the context of the present invention, the term “(meth)acrylic” refers to either acrylic or to methacrylic, or mixtures of acrylic and methacrylic. Correspondingly, the term “(meth)acrylate” refers to either acrylate or to methacrylate, or mixtures of acrylate and methacrylate.

It has been found that the viscosity of the polymer composition can be decreased even further, if R⁴ represents a linear alkyl, alkenyl, or alkinyl group. It is therefore particularly preferred that R⁴ represents a linear alkyl, alkenyl, or alkinyl group.

The compounds according to formula (I) can be characterized based on their degree of linearity. In the context of the present invention the term “degree of linearity” refers to the amount of (meth)acrylic acid esters according to formula (I) having a linear alkyl, alkenyl, or alkinyl group as substituent R⁴ relative to the total weight of (meth)acrylic acid esters according to formula (I). Preferably, the polymers of the present invention are derived from (meth)acrylic acid esters according to formula (I) having a degree of linearity of at least 30%, preferably at least 70%, most preferably 100%. That means that at least 30% by weight, preferably at least 70% by weight, most preferably 100% by weight of the (meth)acrylic acid esters according to formula (I) relative to the total weight of (meth)acrylic acid esters according to formula (I) have a linear alkyl, alkenyl, or alkinyl group as substituent R⁴.

Non-limiting examples of compounds of formula (I) include methyl-(meth)acrylate, ethyl-(meth)acrylate, n-propyl-(meth)acrylate, iso-propyl-(meth)acrylate, n-butyl-(meth)acrylate, tert-butyl-(meth)acrylate, pentyl-(meth)acrylate, cyclopentyl-(meth)acrylate, 2-proynyl-(meth)acrylate, allyl-(meth)acrylate, vinyl-(meth)acrylate, dimethylfumarate, and maleate.

Additional non-limiting examples of compounds of formula (I) include hexyl-(meth)acrylate, 2-ethylhexyl-(meth)acrylate, heptyl-(meth)acrylate, 2-tert-butylheptyl-(meth)acrylate, octyl-(meth)acrylate, 3-isopropyl-heptyl-(meth)acrylate, nonyl-(meth)acrylate, decyl-(meth)acrylate, undecyl-(meth)acrylate, 5-methylundecyl-(meth)acrylate, dodecyl-(meth)acrylate, 2-methyldodecyl-(meth)acrylate, tridecyl-(meth)acrylate, 5-methyltridecyl-(meth)acrylate, tetradecyl-(meth)acrylate, pentadecyl-(meth)acrylate, oleyl-(meth)acrylate, 3-vinylcyclohexyl-(meth)acrylate, cyclohexyl-(meth)acrylate, bornyl-(meth)acrylate, and the corresponding fumarates and maleates.

Further non-limiting examples of compounds of formula (I) include hexadecyl-(meth)acrylate, 2-methylhexadecyl-(meth)acrylate, heptadecyl-(meth)acrylate, 5-isopropylheptadecyl-(meth)acrylate, 4-tert-butyloctadecyl-(meth)acrylate, 5-ethyloctadecyl-(meth)acrylate, 3-isopropyloctadecyl-(meth)acrylate, octadecyl-(meth)acrylate, nonadecyl-(meth)acrylate, eicosyl-(meth)acrylate, cetyleicosyl-(meth)acrylate, stearyleicosyl-(meth)acrylate, docosyl-(meth)acrylate, eicosyltetratriacontyl-(meth)acrylate, 2,4,5-tri-tert-butyl-3-vinyl-cyclohexyl-(meth)acrylate, 2,3,4,5-tetra-tert-butylcyclohexyl-(meth)acrylate, and the corresponding fumarates and maleates.

In another preferred embodiment of the present invention, the polymers are copolymers derived from at least a) an ethylenically unsaturated monomer or a mixture of ethylenically unsaturated monomers, and b) an 1-alkene or mixtures of 1-alkenes. Copolymers of this kind have a particularly low viscosity.

The 1-alkenes preferably are compounds of formula (II)

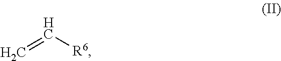

wherein R⁶ is a C₂ to C₃₂ alkyl group.

R⁶ is preferably a C₆ to C₂₀ alkyl group, more preferably a C₆ to C₁₂ alkyl group.

Non-limiting examples of compounds of formula (II) include 1-butene, 1-pentene, 1-hexene, 1-heptene, 1-octene, 1-nonene, 1-decene, 1-undecene, 1-dodecene, 1-tridecene, 1-tetradecene, 1-pentadecene, 1-hexadecene, 1-heptadecene, 1-octadecene, 1-nonadecene, 1-eicosene, 1-heneicosene, 1-docosene, 1-trocosene, 1-tetracosene, 1-pentacosene, 1-hexacosene, 1-heptacosene, 1-octacosene, 1-nonacosene, 1-triacontene, 1-hentriacontene, 1-dotriaconene.

Especially preferred examples of compounds of formula (II) are 1-octene, 1-nonene, 1-decene, 1-undecene, 1-dodecene, 1-tridecene, and 1-tetradecene.

In a particularly preferred embodiment, the 1-alkenes are selected from the group consisting of 1-octene, 1-nonene, 1-decene, 1-undecene, 1-dodecene, 1-tridecene, and 1-tetradecene or mixtures thereof, the ethylenically unsaturated monomers are C₁₀ to C₁₈ (meth)acrylates, and the polymers have a kinematic viscosity of less than 25 mm²/s at 100° C. according to ASTM D 445.

The liquid composition may comprise 10 to 100% by weight of the polymers, preferably 50 to 100% by weight, most preferably 80 to 100% by weight.

The liquid composition of the present invention may further comprise additives selected from the group consisting of antioxidants, anti-wear additives, pour point depressants, corrosion inhibitors, metal passivators, electrostatic discharge depressants, defoaming agents, seal fix or seal compatibility agents, or mixtures thereof.

Preferably, the liquid composition further comprises an antioxidant. The liquid composition may comprise 0.08 to 3% by weight of the antioxidant, preferably 0.08 to 1% by weight, more preferably 0.08 to 0.4% by weight.

Non limiting examples of antioxidants include sterically hindered phenolic or amine antioxidants, for example naphthols, sterically hindered monohydric, dihydric and trihydric phenols, sterically hindered dinuclear, trinuclear and polynuclear phenols, alkylated or styrenated diphenylamines or ionol derived hindered phenols.

Non limiting examples of sterically hindered phenolic antioxidants include 2,6-di-tert-butylphenol, di-tert-butylated hydroxytoluene, methylene-4,4′-bis-(2,6-tert-butylphenol), 2,2′-methylene bis-(4,6-di-tert-butylphenol), 1,6-hexamethylene-bis-(3,5-di-tert-butyl-hydroxyhydrocinnamate), ((3,5-bis(1,1-dimethylethyl)-4-hydroxyphenyl)methyl)thio) acetic acid, C₁₀-C₁₄ isoalkyl esters, 3,5-di-tert-butyl-4-hydroxyhydrocinnamic acid, C₇-C₉ alkyl esters, tetrakis-(3-(3,5-di-tert-butyl-4-hydroxyphenyl)-propionyloxymethyl)methane, thiodiethylene bis(3,5-di-tert-butyl-4-hydroxyhydrocinnamate, octadecyl 3,5-di-tert-butyl-4-hydroxyhydrocinnamate and 2,5-di-tert-butylhydroquinone.

Non-limiting examples of amine antioxidants include aromatic amine antioxidants such as for example N,N′-di-isopropyl-p-phenylenediamine, N,N′-di-sec-butyl-p-phenylenediamine, N,N′-bis(1,4-dimethyl-pentyl)-p-phenylenediamine, N,N′-bis(1-ethyl-3-methyl-pentyl)-p-phenylene-diamine, N,N′-bis(1-methyl-heptyl)-p-phenylenediamine, N,N′-dicyclohexyl-p-phenylene-diamine, N,N′-diphenyl-p-phenylenediamine, N,N′-di(naphthyl-2-)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N′-cyclohexyl-N′-phenyl-p-phenylenediamine, 4-(p-toluene-sulfoamido)diphenylamine, N,N′-dimethyl-N,N′-di-sec-butyl-p-phenylenediamine, diphenylamine, N-allyldiphenylamine, 4-isopropoxy-diphenylamine, N-phenyl-1-naphthylamine, N-phenyl-2-naphthylamine, octylated diphenylamine, e.g. p,p′-di-tert-octyldiphenylamine, 4-n-butylaminophenol, 4-butyrylaminophenol, 4-nonanoylaminophenol, 4-dodecanoylaminophenol, 4-octadecanoylaminophenol, di(4-methoxyphenyl)amine, 2,6-di-tert-butyl-4-dimethyl-aminomethylphenol, 2,4′-diaminodiphenylmethane, 4,4′-diaminodiphenylmethane, N,N,N′,N′-tetramethyl-4,4′-diaminodiphenylmethane, 1,2-di-(phenylamino)ethane, 1,2-di[(2-methylphenyl)amino]ethane, 1,3-di-(phenyl-amino)propane, (o-tolyl)biguanide, di[4-(1′,3′-dimethylbutyl)phenyl]amine, tert-octylated N-phenyl-1-naphthylamine, mixture of mono- and dialkylated tert-butyl-/tert-octyldiphenylamines, 2,3-dihydro-3,3-dimethyl-4H-1,4-benzothiazine, phenothiazine, N-tert-octylated phenothiazine, 3,7-di-tert-octylphenothiazine.

The liquid composition should contain less than 100 ppm by weight of water, preferably less than 60 ppm by weight, most preferably less than 50 ppm by weight.

The polymers of the present invention may be prepared by a method comprising the steps of:
a) preparing a reaction mixture comprising as component A) an ethylenically unsaturated monomer or a mixture of ethylenically unsaturated monomers;
b) adding a Co(II) complex to the reaction mixture;
c) adding a radical initiator; and
d) reacting the reaction mixture to obtain the polymer composition.

The reaction mixture may optionally further comprise a 1-alkene or a mixture of 1-alkenes as component B). In this case the reaction mixture prepared in step a) preferably comprises at least 50% by weight of component A) relative to the total weight of components A) and B). The reaction mixture prepared in step a) also preferably comprises at least 10% by weight of component B) relative to the total weight of components A) and B). Most preferably the reaction mixture prepared in step a) comprises 50 to 90% by weight of component A) and 10 to 50% by weight of component B) relative to the total weight of components A) and B).

If the reaction mixture also comprises a 1-alkene, the method optionally further comprises after step d) an additional step of distilling off the residual 1-alkene.

Preferably, component A) is a mixture comprising as component A1) a compound according to formula (III) or a mixture of a compounds according to formula (III)

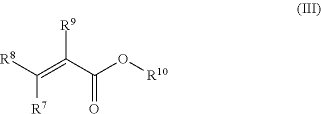

wherein R⁷ and R⁸ independently represent a hydrogen atom or a group of the formula —COOR¹¹, R⁹ represents a hydrogen atom or a methyl group, R¹⁰ represents a C₁ to C₅ alkyl group, a C₂ to C₅ alkenyl group, a C₂ to C₅ alkinyl group or a C₃ to C₅ cycloalkyl group, and R¹¹ represents a hydrogen atom or a C₁ to C₅ alkyl group, a C₂ to C₅ alkenyl group, or a C₂ to C₅ alkinyl group;
as component A2) a compound according to formula (IV) or a mixture of a compounds according to formula (IV)

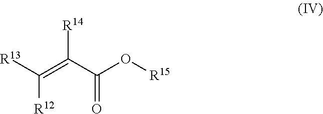

wherein R¹² and R¹³ independently represent a hydrogen atom or a group of the formula —COOR¹⁶, R¹⁴ represents a hydrogen atom or a methyl group, R¹⁵ represents a C₆ to C₁₅ alkyl, alkenyl, or alkinyl group or a C₆ to C₁₅ cycloalkyl group, and R¹⁶ represents a hydrogen atom or a C₆ to C₁₅ alkyl, alkenyl, or alkinyl group; and
as component A3) a compound according to formula (V) or a mixture of a compounds according to formula (V)

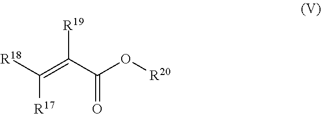

wherein R¹⁷ and R¹⁸ independently represent a hydrogen atom or a group of the formula —COOR²¹, R¹⁹ represents a hydrogen atom or a methyl group, R²⁰ represents a C₁₆ to C₃₀ alkyl, alkenyl, or alkinyl group or a C₁₆ to C₃₀ cycloalkyl group, and R²¹ represents a hydrogen atom or a C₁₆ to C₃₀ alkyl, alkenyl, or alkinyl group.

Preferably, component A) comprises

0 to 15% by weight relative to the total weight of component A) of component A1),
50 to 100% by weight relative to the total weight of component A) of component A2), and
0 to 50% by weight relative to the total weight of component A) of component A3),
wherein the amounts of components A1) to A3) add up to 100% by weight relative to the total weight of component A).

By adding the Co(II) complex, polymer compositions of extremely low viscosity can be produced. To achieve a low viscosity, the amount of Co(II) added to the reaction mixture in the form of a Co(II) complex is preferably at least 30 ppm by weight of Co(II) relative to the total weight of component A) or, if component B) is present, relative to the total weight of components A) and B), more preferably at least 50 ppm by weight, most preferably in the range of 50 to 100 ppm by weight.

Suitable examples of Co(II) complexes of the present invention include complexes comprising Co(II) and at least one of the ligands according to formulae (VI) to (XI)

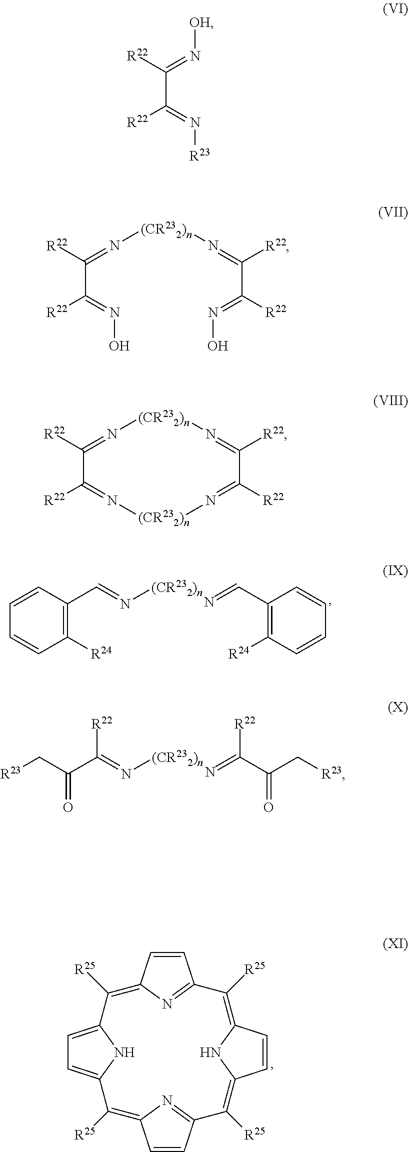

wherein each R²² independently represents a phenyl group or a C₁ to C₁₂ alkyl group, or two R²² on adjacent carbon atoms together represent a C₅ to C₈ alkylene group; each R²³ independently represents a hydrogen atom or a C₁ to C₁₂ alkyl group; each R²⁴ independently represents a hydroxyl group or an amino group; each R²⁵ independently represents a hydrogen atom, a C₁ to C₁₂ alkyl group, a phenyl group, a hydroxyphenyl group, or a C₁ to C₄ alkoxyphenyl group; and each n represents an integer 2 or 3.

In a particularly preferred embodiment the Co(II) complex comprises Co(II) and a ligand of formula (XI). More preferably, the Co(II) complex is 5,10,15,20-tetraphenyl-porphine Co(II).

The radical initiator used in the inventive method may be any free radical initiator suitable for use in radical polymerization reactions. Such radical initiators are well known in the art. Azo compounds are particularly preferred radical initiators.

The total amount of the radical initiator added to the reaction mixture is at least 0.05% by weight relative to the total weight of component A) or, if component B) is present, relative to the total weight of components A) and B), preferably in the range of 0.1 to 3.5% by weight. It has surprisingly been found that by varying the amount of initiator, polymer compositions of different viscosity and different pour points may be produced. To achieve a particularly low viscosity, the total amount of initiator added to the reaction mixture is preferably 0.1 to 1.75% by weight relative to the total weight of component A) or, if component B) is present, relative to the total weight of components A) and B).

The radical initiator may be added to the reaction mixture in a step wise fashion to ensure that the radical initiator does not get depleted too quickly during long polymerization times. For example, a first dose of the radical initiator is added to the reaction mixture to start the polymerization reaction, then the reaction is allowed to proceed for a certain amount of time, then an additional dose initiator is added, and so on. The total amount added in all steps, however, should not exceed the preferred total amount of radical initiator mentioned above. The time interval between the additions of the different doses of radical initiator may be in the range of 10 minutes to 5 hours, preferably 30 to 120 minutes.

Examples of suitable radical initiators include azo-compounds such as azobisisobutylonitrile (AIBN), 2,2′-Azobis(2-methylbutyronitrile), and 1,1-azobiscyclohexanecarbonitrile; peroxy compounds such as methyl-ethyl-ketone peroxide, acetylacetone peroxide, dilauryl peroxide, tert-butyl per-2-ethylhexaneoate, ketone peroxide, tert-butyl peroctoate, methyl isobutyl ketone peroxide, cyclohexanone peroxide, dibenzoyl peroxide, tert-butyl peroxybenzoate, tert-butyl peroxyisopropylcarbonate, 2,5-bis(2-ethylhexanoylperoxy)-2,5-di methyl hexane, tert-butyl peroxy-2-ethyl hexanoate, tert-butyl-peroxy-3,5,5-trimethylhexanoate, dicumyl peroxide, 1,1-bis(tert-butylperoxy)cyclohexane, 1,1-bis(tert-butylperoxy)-3,3,5-trimethylcyclohexane, cumyl hydroperoxide, tert-butyl hydroperoxide, and bis(4-tert-butylcyclohexyl) peroxydicarbonate; and mixtures of the aforementioned compounds.

The reaction mixture may be reacted in step d) at standard ambient pressure, reduced pressure or elevated pressure. The reaction temperature may in the range of −20° C. to 200° C., preferably 50° C. to 150° C., more preferably 80° C. to 130° C.

In a preferred embodiment, the addition of the radical initiator in step c) and the reaction in step d) take place in an inert gas atmosphere to prevent degradation of the radical initiator. Preferably, nitrogen gas is used as inert gas.

The reaction may be allowed to proceed in step d) for up to 12 hours, preferably for up to 6 hours, more preferably for 10 minutes to 6 hours.

### EXAMPLES

In the following examples, PAO 8 is a polyalphaolefin with a kinematic viscosity at 100° C. according to ASTM D 445 of 8 mm²/s. PAO 40 is a polyalphaolefin with a kinematic viscosity at 100° C. according to ASTM D 445 of 40 mm²/s.

Isodecyl-methacrylate (IDMA) is a mixture consisting of 98.7% by weight C₁₀ methacrylate, 0.8% by weight C₁₂ methacrylate, and 0.5% by weight C₁₄ methacrylate. The degree of linearity of IDMA is 0%.

Methacrylate from LIAL® 125 alcohol (LIMA) is a mixture consisting of 24.3% by weight C₁₂ methacrylate, 29.4% by weight C₁₃ methacrylate, 28.4% by weight C₁₄ methacrylate, and 17.9% by weight C₁₅ methacrylate. The degree of linearity of LIMA is 40%.

Lauryl methacrylate (LMA) is a mixture consisting of 72.2% by weight C₁₂ methacrylate, and 27.8% by weight C₁₄ methacrylate. The degree of linearity of LIAL is 100%.

Stearyl methacrylate (SMA) is a mixture consisting of 29.3% by weight C₁₆ methacrylate, 69.8% by weight C₁₈ methacrylate, and 0.8% by weight C₂₀ methacrylate. The degree of linearity of SMA is 100%.

### Example 1

In a 2 L kettle, a monomer mixture containing 365.7 gram SMA and 297.8 gram IDMA was diluted with 279 gram 1-decene. To this mixture, 90 gram of a 1% by weight 5,10,15,20-Tetraphenyl Porphine Cobalt(II) solution in tetrahydrofuran was added. The mixture was degassed and heated to 120° C. At this temperature, 4.4 gram of 2,2-bis(t-butylperoxy)butane were introduced every 30 minutes for a total number of six times. The temperature of the reaction increased to 140° C. following the exotherm of the reaction. After the last initiator introduction, the mixture was stirred for one additional hour. After that, tonsil (5%) was added to the mixture. With the help of tonsil, the turbid brown-colored product was filtered through K250 Seitz filter, followed by rotary vacuum evaporation at 150° C. to remove the remaining 1-decene. The filtration step was repeated twice until the product was no longer turbid (clear, orange-colored).

The residual concentration of 1-decene in the product was 0.02% as determined by HPLC. The number average molecular weight (Mₙ) of the polymer estimated by gel permeable chromatography (GPC) was 1300 g/mol. The polydispersity index was 1.35. The kinematic viscosity at 100° C. according to ASTM D 445 was 12.1 mm²/s.

### Example 2

### Comparative Example

Example 2 was prepared by blending 71′)/0 PAO and 29% PAO 40 to reach a target kinematic viscosity at 100° C. according to ASTM D 445 of 12 mm²/s. The measured kinematic viscosity at 100° C. according to ASTM D 445 was 12.3 mm²/s.

### Example 3

Example 3 was prepared as example 1, except that 672.1 gram of LMA and 288.1 gram 1-decene were used as monomers.

The residual concentration of 1-decene in the product was 0.32% as determined by HPLC. The number average molecular weight (Mₙ) of the polymer estimated by gel permeable chromatography (GPC) was 1480 g/mol. The polydispersity index was 1.41. The kinematic viscosity at 100° C. according to ASTM D 445 was 12.7 mm²/s.

### Example 4

### Comparative Example

Example 4 was prepared by blending 68% PAO 8 and 32% PAO 40 to reach a target kinematic viscosity at 100° C. according to ASTM D 445 of 13 mm²/s. The measured kinematic viscosity at 100° C. according to ASTM D 445 was 12.9 mm²/s.

### Example 5

Example 5 was prepared as example 1, except that 372.8 gram of LIMA, 303.6 gram IDMA and 284.4 gram 1-decene were used as monomers.

The residual concentration of 1-decene in the product was 0.02% as determined by HPLC. The number average molecular weight (Mₙ) of the polymer estimated by gel permeable chromatography (GPC) was 1250 g/mol. The polydispersity index was 1.43. The kinematic viscosity at 100° C. according to ASTM D 445 was 13.8 mm²/s.

### Example 6

### Comparative Example

Example 6 was prepared by blending 62% PAO 8 and 38% PAO 40 to reach a target kinematic viscosity at 100° C. according to ASTM D 445 of 14 mm²/s. The measured kinematic viscosity at 100° C. according to ASTM D 445 was 14.2 mm²/s.

### Measurements of Heat Capacity and Electric Conductivity

The electrical conductivity value was by using electrical conductivity analyzer MLA900 for oil-based fluid, as described in ASTM D2624. The heat capacity evaluation was be derived from the differential scanning calorimetry (DSC) analysis. The DSC analysis was carried out in aluminum pans with perforated lids under nitrogen inert. The samples were heated up from 0 to 120° C. at heating rate 5K/min. The heat capacity determination at various temperatures was evaluated as per description in ASTM E1269-11.

Table 1 summarizes the kinematic viscosities, heat capacities, and electric conductivities of examples 1 to 6. The direct comparison of the lubricating compositions of the present invention (examples 1, 3, and 5) with PAO-based compositions (examples 2, 4, and 6) of similar kinematic viscosity demonstrates that the inventive compositions have a higher heat capacity than PAO-based compositions of similar kinematic viscosity at temperatures between 20 and 100° C.

TABLE 1
Properties of examples 1 to 6.

| | measurement | | | | | | |
|---|---|---|---|---|---|---|---|
| | temperature | | | | | | |
| Property | [° C.] | 1 | 2 | 3 | 4 | 5 | 6 |
| Kinematic | 100 | 12.1 | 12.3 | 12.7 | 12.9 | 13.8 | 14.2 |
| viscosity | | | | | | | |
| [mm²/s] | | | | | | | |
| Heat | 20 | 2.01 | 1.92 | 1.92 | 1.73 | 1.90 | 1.73 |
| capacity | 40 | 2.08 | 1.98 | 1.97 | 1.77 | 1.96 | 1.79 |
| [kJ/kg/K] | 60 | 2.15 | 2.06 | 1.95 | 1.83 | 2.04 | 1.86 |
| | 100 | 2.24 | 2.25 | 2.14 | 2.00 | 2.19 | 2.04 |
| Electrical | 20 | 20 | <1 | 25 | <1 | 4 | <1 |
| conductivity | | | | | | | |
| [pS/m] | | | | | | | |

1. Use of a liquid composition as heat transfer fluid, characterized in that the liquid composition comprises polymers derived from at least an ethylenically unsaturated monomer or of a mixture of ethylenically unsaturated monomers.

2. The use of a liquid composition according to claim 1, characterized in that the ethylenically unsaturated monomer or the mixture of ethylenically unsaturated monomers is a compound according to formula (I) or a mixture of compounds according to formula (I) 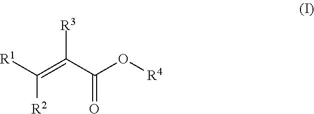
wherein R¹ and R² independently represent a hydrogen atom or a group of the formula —COOR⁵, R³ represents a hydrogen atom or a methyl group, R⁴ represents a C₁ to C₃₀ alkyl group, a C₂ to C₃₀ alkenyl group, a C₂ to C₃₀ alkinyl group or a C₃ to C₃₀ cycloalkyl group, and R⁵ represents a hydrogen atom or a C₁ to C₃₀ alkyl group, a C₂ to C₃₀ alkenyl group, or a C₂ to C₃₀ alkinyl group.

3. The use of a liquid composition according to claim 2, characterized in that R¹ and R² represent hydrogen atoms and R⁴ represents a C₁ to C₃₀ alkyl group.

4. The use of a liquid composition according to claim 1, characterized in that the polymers are copolymers derived from at least
a) an ethylenically unsaturated monomer or a mixture of ethylenically unsaturated monomers, and
b) an 1-alkene or a mixture of 1-alkenes.

5. The use of a liquid composition according to claim 4, characterized in that the 1-alkene or the mixture of 1-alkenes is a compound according to formula (II) or a mixture of compounds according to formula (II) 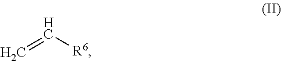
wherein R⁶ is a C₂ to C₃₂ alkyl group.

6. The use of a liquid composition according to claim 1, characterized in that the liquid composition comprises 10 to 100% by weight of the polymers.

7. The use of a liquid composition according to claim 1, characterized in that the liquid composition further comprises additives selected from the group consisting of antioxidants, anti-wear additives, pour point depressants, corrosion inhibitors, metal passivators or electrostatic discharge depressants, defoaming agents, seal fix or seal compatibility agents, or mixtures thereof.

8. The use of a liquid composition according to claim 1, characterized in that the liquid composition comprises less than 100 ppm by weight of water.

9. The use of a liquid composition according to claim 1, characterized in that the liquid composition is used as heat transfer fluid for electrical equipment.

10. The use of a liquid composition according to claim 9, characterized in that the electrical equipment is selected from the group consisting of electric batteries, electric motors, electric transformers, electric power converters, electric capacitors, fluid-filled transmission lines, fluid-filled power cables, and computers.

11. The use of a liquid composition according to claim 1, characterized in that the liquid composition has a specific heat capacity of at least 1.80 kJ/kg/K at 40° C. according to ASTM E 1269.

12. The use of a liquid composition according to claim 1, characterized in that the polymers have a kinematic viscosity of less than 100 mm²/s measured at 100° C. according to ASTM D 445.
